(19) United States
(12) Patent Application Publication
(10) Pub. No.: US 2019/0176532 A1
(43) Pub. Date: Jun. 13, 2019

(54) PNEUMATIC TIRE

(71) Applicant: Toyo Tire & Rubber Co., Ltd., Itami-shi (JP)

(72) Inventor: Toshikazu Yasunaga, Itami-shi (JP)

(73) Assignee: Toyo Tire & Rubber Co., Ltd., Itami-shi (JP)

(21) Appl. No.: 16/210,789

(22) Filed: Dec. 5, 2018

(30) Foreign Application Priority Data
Dec. 13, 2017 (JP) 2017-238876

(51) Int. Cl. B60C 11/12; B60C 11/04

(52) U.S. Cl. CPC B60C 11/1204; B60C 11/1236; B60C 11/1272; B60C 2011/0346; B60C 2011/1213; B60C 2011/1227; B60C 2011/1245; B60C 11/042

(57) ABSTRACT

To obtain a uniform ground contact pressure distribution in a pneumatic tire including a zigzag-shaped sipe. In a pneumatic tire according to an embodiment, a land portion formed in a tread portion is provided with a zigzag-shaped sipe extending in a tire circumferential direction. The zigzag-shaped sipe is formed in a zigzag shape by a plurality of lateral sipe portions arranged at intervals in the tire circumferential direction and a plurality of longitudinal sipe portions alternately connecting the end portions thereof. Each longitudinal sipe portion includes an extension portion in which one end portion (for example, an end portion on a rear side in a rotation direction) of both end portions in the tire circumferential direction extends to the one side beyond a connection portion with the lateral sipe portion.

### CROSS-REFERENCE TO RELATED APPLICATIONS

This application is based upon and claims the benefit of priority from the prior Japanese Patent Application No. 2017-238876, filed on Dec. 13, 2017; the entire contents of which are incorporated herein by reference.

### BACKGROUND

### 1. Technical Field

An embodiment of the present invention relates to a pneumatic tire.

### 2. Description of the Related Art

Conventionally, a pneumatic tire in which a plurality of sipes are provided in a land portion formed in a tread portion is known for the purpose of improving performance of the pneumatic tire on icy and snowy roads.

For example, JP-A-2007-030686 discloses a structure with a zigzag-shaped sipe extending in a tire circumferential direction using a tire width direction as an amplitude direction as a structure easily obtaining moderate deflection for improving performance on ice. The zigzag-shaped sipe is formed in a zigzag shape by a plurality of lateral sipe portions arranged at intervals in the tire circumferential direction and a plurality of longitudinal sipe portions alternately connecting end portions of the lateral sipe portions. For that reason, there is a large difference in rigidity between a bag-shaped portion connected by the longitudinal sipe portion and an opening portion (a portion facing the bag-shaped portion in the tire width direction) not connected by the longitudinal sipe portion. Accordingly, since a ground contact pressure distribution becomes non-uniform, it is difficult to sufficiently exhibit performance such as traction performance, uneven wear resistance, and performance on ice.

### SUMMARY

An object of an embodiment of the invention is to obtain a uniform ground contact pressure distribution in a pneumatic tire including a zigzag-shaped sipe.

A pneumatic tire according to an embodiment of the invention is a pneumatic tire in which a land portion formed in a tread portion is provided with a zigzag-shaped sipe extending in a tire circumferential direction, in which the zigzag-shaped sipe is formed in a zigzag shape by a plurality of lateral sipe portions arranged at intervals in the tire circumferential direction and a plurality of longitudinal sipe portions alternately connecting end portions of the lateral sipe portions, and each longitudinal sipe portion includes an extension portion in which one end portion out of both end portions in the tire circumferential direction of each longitudinal sipe portion extends to the one side beyond a connection portion with the lateral sipe portion.

According to the embodiment, it is possible to obtain a uniform ground contact pressure distribution in a tire including a zigzag-shaped sipe.

### BRIEF DESCRIPTION OF THE DRAWINGS

FIG. 1 is a developed view illustrating a tread pattern of a pneumatic tire according to an embodiment.

FIG. 2 is an enlarged view of a main part of the tread pattern.

### DETAILED DESCRIPTION

Hereinafter, an embodiment will be described with reference to the drawings.

Although not illustrated in the drawings, a pneumatic tire according to an embodiment includes a pair of right and left bead portions, a pair of right and left sidewall portions, and a tread portion provided between both sidewall portions to connect outer end portions of the right and left sidewall portions in the radial direction and a general tire structure can be used for a structure other than a tread pattern.

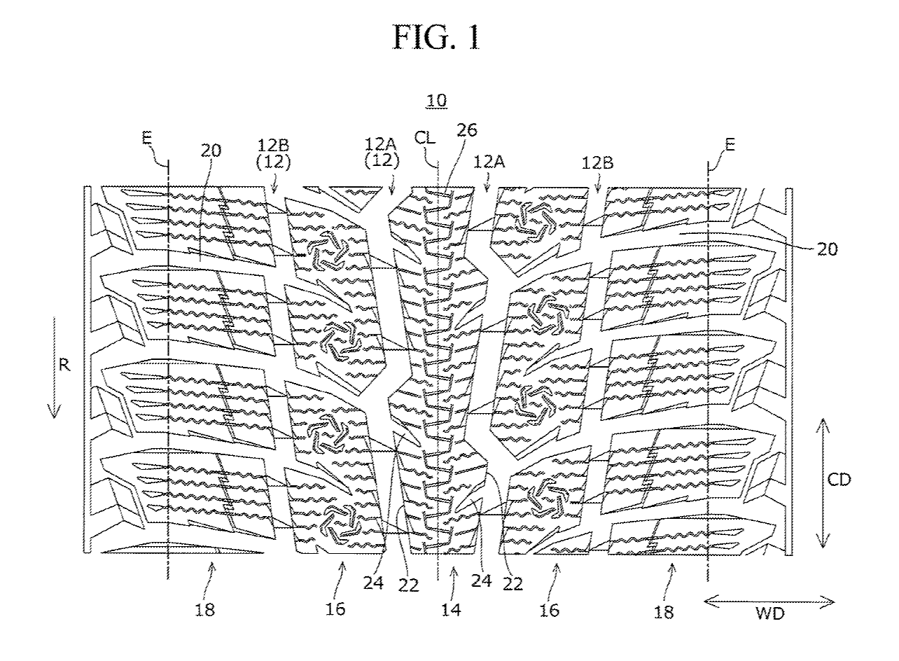

As illustrated in FIG. 1, a tread rubber surface of a tread portion 10 is provided with a plurality of main grooves 12 extending in a tire circumferential direction CD and in this example, four main grooves are formed at intervals in a tire width direction WD. That is, a pair of center main grooves 12A and 12A provided at both sides of a tire equator CL and a pair of shoulder main grooves 12B and 12B respectively disposed at the outside thereof are provided. Four main grooves 12 are zigzag-shaped grooves which extend in the tire circumferential direction CD while being bent with an amplitude in the tire width direction WD. Furthermore, in FIG. 1, Reference Sign E indicates a ground contact end.

The pneumatic tire is a tire having a specified rotation direction and in the drawings, the rotation direction is indicated by Reference Sign R. The pneumatic tire is attached to a vehicle so that the tire rotates in a direction indicated by the arrow R when the vehicle runs forward. As a mark for this purpose, a display for designating the rotation direction is provided on, for example, the sidewall portion or the like of the pneumatic tire.

In the tread portion 10, a plurality of land portions are divided by the main groove 12 in the tire width direction WD. Specifically, a center land portion 14 interposed between the pair of center main grooves 12A and 12A, a pair of right and left intermediate land portions 16 and 16 interposed between the center main groove 12A and the shoulder main groove 12B, and a pair of right and left shoulder land portions 18 and 18 located at the outside of the shoulder main groove 12B in the tire width direction are provided. The intermediate land portion 16 and the shoulder land portion 18 are formed as a block row in which a plurality of blocks are arranged in the tire circumferential direction CD in such a manner that a plurality of lateral grooves 20 are provided at intervals in the tire circumferential direction CD. Meanwhile, the center land portion 14 is not divided by the lateral groove and is formed as a rib which is continuous in the entire circumference of the tire circumferential direction CD.

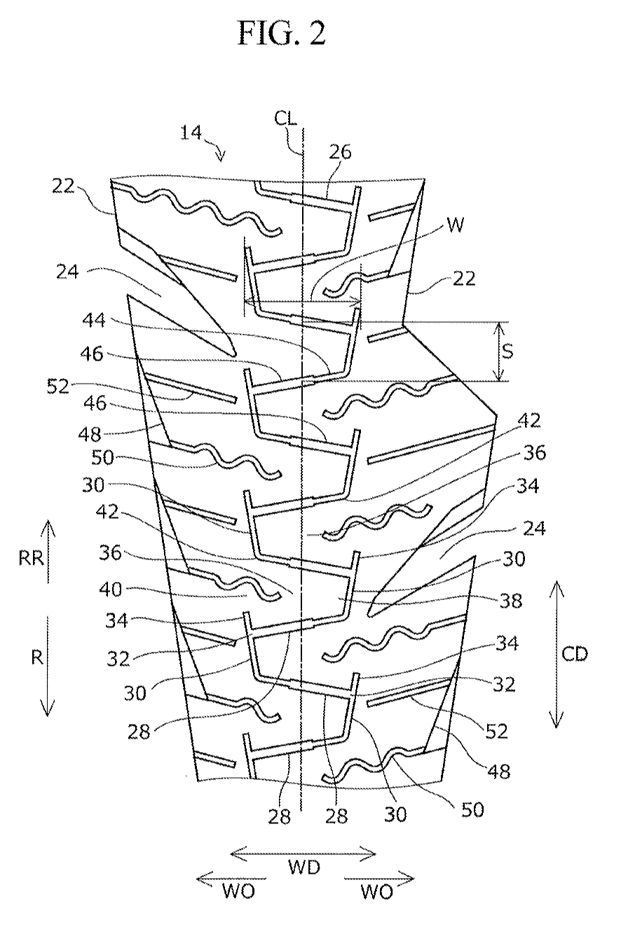

The embodiment has a characteristic in the configuration of the center land portion 14 and the configuration of the center land portion 14 will be described in detail below with reference to FIGS. 1 and 2.

The center land portion 14 is a rib which extends on the tire equator CL in the tire circumferential direction CD and a pair of right and left side walls 22 of the center land portion 14 is formed in a zigzag shape by the zigzag-shaped center main grooves 12A and 12A at both sides. Further, in the center land portion 14, lateral grooves 24 not penetrating the center land portion 14 are alternately provided on the right and left sides at intervals in the tire circumferential direction CD. The lateral groove 24 is formed as a leading end portion of the lateral groove 20 on the extension line of the lateral groove 20 crossing the intermediate land portion 16 and the shoulder land portion 18.

The center portion of the center land portion 14 is provided with a zigzag-shaped sipe 26 which continuously extends in the tire circumferential direction CD. In this example, the zigzag-shaped sipe 26 extends in the entire circumference of the tire circumferential direction CD on the tire equator CL at the center portion of the center land portion 14 in the width direction. The zigzag-shaped sipe 26 is a sipe which does not open the main groove 12 and is a wavy sipe in which the tire width direction WD substantially matches the amplitude direction. The sipe extends in the tire circumferential direction CD while swinging in the tire width direction WD with a predetermined amplitude. Furthermore, a width W (corresponding to double the amplitude) of the zigzag-shaped sipe 26 is not particularly limited and may be, for example, 8 to 20 mm.

As illustrated in FIG. 2, the zigzag-shaped sipe 26 is formed in a zigzag (that is, winding) cross-sectional shape by a plurality of lateral sipe portions 28 which are arranged at intervals in the tire circumferential direction CD and a plurality of longitudinal sipe portions 30 which alternately connect the end portions of the lateral sipe portions 28 at the right and left sides.

The lateral sipe portion 28 is a sipe which extends in the tire width direction WD and in this example, the lateral sipe portion has a straight cross-sectional shape and is inclined with respect to the tire width direction WD. The inclination angle with respect to the tire width direction WD is not particularly limited and may be, for example, 30° or less or 20° or less. In this example, the lateral sipe portions 28 and 28 which are adjacent to each other in the tire circumferential direction CD are not parallel to each other and are inclined in the opposite directions with respect to the tire width direction WD. A gap between the adjacent lateral sipe portions 28 and 28 is not particularly limited and may be, for example, 4 to 10 mm in the interval S at the amplitude center.

The longitudinal sipe portion 30 is a sipe which extends in the tire circumferential direction CD. In this example, the longitudinal sipe portion 30 has a straight cross-sectional shape and is inclined with respect to the tire circumferential direction CD. The inclination angle with respect to the tire circumferential direction CD is not particularly limited and may be, for example, 30° or less or 20° or less. The longitudinal sipe portion 30 is a sipe which alternately connects the facing end portions of the lateral sipe portions 28 and 28 adjacent to each other in the tire circumferential direction CD on the right and left sides in the tire circumferential direction CD and connects the end portions having a short distance therebetween in the adjacent lateral sipe portions 28 in both end portions of the lateral sipe portion 28.

Each longitudinal sipe portion 30 includes an extension portion 34 which is formed by extending only one end portion out of both end portions in the tire circumferential direction CD of each longitudinal sipe portion 30 to one side beyond a connection portion 32 with the lateral sipe portion 28. That is, the extension portion 34 is an extended portion of one end portion out of both end portions of the longitudinal sipe portion 30 to the one side beyond a connection portion 32. In this example, each longitudinal sipe portion 30 is provided with the extension portion 34 in which only the end portion on the rear side RR in the rotation direction out of both end portions of each longitudinal sipe portion 30 goes beyond the connection portion 32 with the lateral sipe portion 28, extends to the rear side RR, and is terminated. Here, the rear side RR in the rotation direction indicates an opposite direction with respect to the rotation direction R. In this way, each of the longitudinal sipe portions 30 alternately disposed at the right and left sides is formed so that the end portion on the rear side RR in the rotation direction protrudes to the rear side RR and the protruding portion is formed as the extension portion 34.

In a land portion 36 between the pair of adjacent lateral sipe portions 28 and 28, one end side of the tire width direction WD is connected by the longitudinal sipe portion 30 and is formed in a bag-shaped (that is, closed) portion 38 and the other end side thereof is formed in an opening portion 40 opening to the outside WO in the width direction of the zigzag-shaped sipe 26. The extension portion 34 is provided so that an opening width of the opening portion 40 on the stepping side of the land portion 36 (the front side R in the rotation direction) decreases and is not provided on the kicking side of the land portion 36 (the rear side RR in the rotation direction). That is, the kicking side is not provided with the extension portion protruding toward the opening portion 40 from a bent portion 42 obtained by connecting the lateral sipe portion 28 and the longitudinal sipe portion 30 and the opening portion 40 is formed between the kicking side bent portion 42 and the stepping side extension portion 34 to open to the outside WO in the width direction. Here, the outside WO in the width direction indicates a direction moving away from the center (amplitude center) of the zigzag-shaped sipe 26 in the width direction and is the same as the outside of the tire width direction WD in this example.

The longitudinal sipe portion 30 is inclined to the outside WO in the width direction from the other end portion of the tire circumferential direction CD (the end portion opposite to the one end portion) toward the front end of the extension portion 34. In this example, the longitudinal sipe portion 30 is provided to be inclined to the outside WO in the width direction toward the rear side RR in the rotation direction. That is, the longitudinal sipe portion is formed in a shape opening outward.

The zigzag-shaped sipe 26 is provided with a wide portion 46 having a groove width wider than that of a narrow portion 44 which is the other portion. In this example, the wide portion 46 is provided in a part of the lateral sipe portion 28 (specifically, about half the length) and is alternately disposed at the right and left sides in the tire circumferential direction CD. Meanwhile, all of the longitudinal sipe portion 30 is formed as the narrow portion 44.

The groove width of the narrow portion 44 is not particularly limited and may be, for example, 0.1 to 0.6 mm or 0.2 to 0.5 mm. The groove width of the wide portion 46 is not particularly limited as long as the groove width is wider than the groove width of the narrow portion 44 and may be, for example, 0.3 to 1.0 mm or 0.5 to 0.8 mm. Furthermore, the groove depth of the zigzag-shaped sipe 26 is not particularly limited and may be, for example, 30 to 80% of the main groove depth.

The center land portion 14 is further provided with a triangular notch portion 48 provided at each of both side walls 22 and 22 and the notch portion 48 is provided at a plurality of positions at intervals in the tire circumferential direction CD. The center land portion 14 is further provided with a wavy sipe 50 extending in the tire width direction WD and having a wavy cross-sectional shape and a straight sipe 52 extending in the tire width direction WD and having a straight cross-sectional shape. The wavy sipe 50 and the straight sipe 52 are basically formed to open to the side wall 22 of the center land portion 14 and are terminated so as not to intersect the zigzag-shaped sipe 26. The wavy sipe 50 and the straight sipe 52 are alternately disposed in the tire circumferential direction CD.

According to the pneumatic tire of the embodiment with the above-described configuration, since the zigzag-shaped sipe 26 is provided, it is possible to improve the traction performance or the braking performance in the longitudinal direction (the tire circumferential direction CD) by the lateral sipe portion 28 and to exhibit the edge effect in the lateral direction (the tire width direction WD) by the longitudinal sipe portion 30. Accordingly, it is possible to improve the running performance such as performance on ice. Further, since the extension portion 34 is provided in each longitudinal sipe portion 30, it is possible to improve the edge performance particularly in the lateral direction. At the same time, since it is possible to decrease the rigidity of the opening portion 40 by the extension portion 34 in the land portion 36 formed between the pair of lateral sipe portions 28 and 28, it is possible to decrease a difference in rigidity between the bag-shaped portion 38 and the opening portion 40 and to obtain a uniform ground contact pressure distribution. For that reason, it is easy to exhibit the traction performance, the uneven wear resistance, or the performance on ice.

Further, since the extension portion 34 is provided on the stepping side of the land portion 36 and the extension portion 34 is not provided on the kicking side thereof, it is possible to ensure the rigidity of the kicking side bent portion 42 and to improve the braking performance.

Further, since the longitudinal sipe portion 30 is provided to be inclined to the outside WO in the width direction toward the front end of the extension portion 34, it is possible to ensure a distance between the front end of the stepping side extension portion 34 and the kicking side bent portion 42 and to further ensure the rigidity of the portion.

Further, since the zigzag-shaped sipe 26 is provided with the wide portion 46 along with the narrow portion 44, it is possible to maintain an edge effect or a water removal effect in the wide portion 46 even when the narrow portion 44 is closed at the time of braking the tire.

Furthermore, in the above-described embodiment, an example in which the zigzag-shaped sipe 26 is provided in the center land portion 14 extending on the tire equator CL has been described, but the zigzag-shaped sipe may be provided in the land portion not existing on the tire equator. Further, the number of the zigzag-shaped sipes is not particularly limited and may be plural. Further, the configuration of the intermediate land portion 16 or the shoulder land portion 18 is not limited to one illustrated in FIG. 1 and various configurations can be employed.

Further, in the above-described embodiment, the lateral sipe portion 28 and the longitudinal sipe portion 30 are formed in a straight cross-sectional shape, but may be formed in a curved cross-sectional shape or a combination of the straight shape and the curved shape. Further, in the above-described embodiment, an example in which the zigzag-shaped sipe 26 is continuous in the tire circumferential direction CD without any interruption has been described, but the zigzag-shaped sipe may include one or plural divided portions. Further, in the above-described embodiment, the zigzag-shaped sipe 26 is provided with the wide portion 46, but the wide portion 46 is not essential.

Furthermore, the dimensions in the specification are those in a normal state without any load in a state in which a pneumatic tire is mounted on a regular rim and is filled with a normal internal pressure. The regular rim is “Standard Rim” in the JATMA standard, “Design Rim” in the TRA standard, or “Measuring Rim” in the ETRTO standard. The normal internal pressure is “MAXIMUM AIR PRESSURE” in the JATMA standard, the “maximum value” described in “TIRE LOAD LIMITS AT VARIOUS COLD INFLATION PRESSURES” in the TRA standard, or “INFLATION PRESSURE” in the ETRTO standard.

As the pneumatic tire according to the embodiment, tires for various vehicles such as a tire for a passenger car and a heavy duty tire for a truck, a bus, or a light truck (for example, a SUV car and a pickup truck) can be exemplified. Further, the application of the pneumatic tire is not particularly limited and the pneumatic tire may be used as all season tires and winter tires.

Although several embodiments have been described above, these embodiments have been suggested as an example and are not intended to limit the scope of the invention. These embodiments can be implemented in various other forms and can be implemented while being omitted, replaced, or changed in various ways without departing from the gist of the invention. These embodiments and modifications thereof are included in the scope and gist of the invention as well as in the scope of the invention described in the claims and their equivalents.

What is claimed is:

1. A pneumatic tire in which a land portion formed in a tread portion is provided with a zigzag-shaped sipe extending in a tire circumferential direction,
wherein the zigzag-shaped sipe is formed in a zigzag shape by a plurality of lateral sipe portions arranged at intervals in the tire circumferential direction and a plurality of longitudinal sipe portions alternately connecting end portions of the lateral sipe portions, and
each longitudinal sipe portion includes an extension portion in which one end portion out of both end portions in the tire circumferential direction of each longitudinal sipe portion extends to the one side beyond a connection portion with the lateral sipe portion.

2. The pneumatic tire according to claim 1,
wherein the longitudinal sipe portion is inclined outward in a width direction from the other end portion in the tire circumferential direction toward a front end of the extension portion.

3. The pneumatic tire according to claim 1,
wherein the pneumatic tire is a tire having a specified rotation direction, and the extension portion is formed by extending an end portion of each longitudinal sipe portion on a rear side in a rotation direction to the rear side beyond the connection portion with the lateral sipe portion.

4. The pneumatic tire according to claim 2,
wherein the pneumatic tire is a tire having a specified rotation direction, and the extension portion is formed by extending an end portion of each longitudinal sipe portion on a rear side in a rotation direction to the rear side beyond the connection portion with the lateral sipe portion.
